(19) United States
(12) Patent Application Publication
(10) Pub. No.: US 2019/0356936 A9
(43) Pub. Date: Nov. 21, 2019

(54) System for georeferenced, geo-oriented realtime video streams

(71) Applicant: ADCOR MAGnet Systems, LLC, Baltimore, MD (US)

(72) Inventors: Evangelos Foutzitzis, Nottingham, MD (US); Javier Santoro, Victoria (CA)

(73) Assignee: ADCOR MAGnet Systems, LLC, Baltimore, MD (US)

(21) Appl. No.: 15/530,878

(22) Filed: Mar. 13, 2017

Related U.S. Application Data
(60) Provisional application No. 62/390,021, filed on Mar. 16, 2016.

(51) Int. Cl. H04N 21/236; H04N 21/234; G06F 17/30; G01C 11/02

(52) U.S. Cl. CPC H04N 21/23614; H04N 21/23418; G06T 2207/30; G01C 11/02; G06F 17/30244; G06F 17/30241

(57) ABSTRACT

A system for creating a composite georeferenced, geo-oriented geospatial/realtime image by combining prestored geographic data with realtime video streams and state data characterizing the source of the realtime video stream and visually displaying the composite image under a user's realtime control.

### PRIORITY

This applications claims priority from U. S. Provisional Application, filed Mar. 15, 2016, which is incorporated herein by reference.

### FIELD OF THE INVENTION

The present invention relates generally to remote imaging and to geographic information systems, and more particularly, to a system for generating georeferenced, geo-oriented realtime video streams.

### BACKGROUND OF THE INVENTION

Definitions

“Include” or “including” means “including but not limited to.” “For example” refers to one possible example and is not meant to limit or exclude others.

“Georeferencing” generally means associating an object with coordinates in a reference system, for example latitude, longitude, and elevation, also referred to as location metadata.

“Geo-orienting” generally refers to the action of orienting an object relative to the points of a magnetic or digital compass or other specified positions. In digital media i.e. GIS computer program applications, Geo-orientation refers to the process of displaying the said object as a different layer on a computer generated map with specific compass bearing, roll and pitch angles to superimpose its exact attitude with regards to the geographic environment, and permitting a user to control the viewpoint from which the combined image is viewed.

Global Positioning Systems, (“GPS”) are available and permit establishing the location of an object. Geographical Information Systems (“GIS”) are available and permit displays representing the physical appearance of locations on a virtual map of the world. One widely available GIS, Google® Earth, allows rendering a map of a given location and also allows display of icons or images representing structures at the displayed location. The images used by Google® Earth are historical, representing the appearance as of the last time that particular location was captured for the Google database.

### BACKGROUND

Remote video acquisition may be accomplished using various platforms, including satellites, drones, unmanned aerial vehicles, remote-controlled cameras or cell phones.

It would be desirable to be able to place remotely acquired video in context by creating a hybrid video stream, combining the remotely acquired video with pre-stored data representing the geography of the location at which the video was acquired, particularly if the hybrid video could be updated in realtime, and even more so if a user could control the viewpoint from which the hybrid video would be displayed. Many U.S. patents have been directed to visualization of remotely acquired images or geospatial information. For example, U.S. Pat. No. 6,484,101 generates geo-spatial objects which are assigned location data and represented on a map. It does not, however, disclose or suggest projecting realtime geo-referenced video feeds on the map nor does it disclose or suggest 3-Dimensional representations. U.S. Pat. No. 8,997,521 discloses 3-Dimensional models on a map. It does not, however, disclose or suggest realtime projection or video projection.

U.S. Pat. No. 8,942,483 compares still, non-georeferenced, images against georeferenced images included in a database of georeferenced imagery. If a match is found, then it outputs a correlation identifier stating that a match has been found and that the location of the non-georeferenced imagery has been resolved; i.e. it is used to identify the location at which a particular image has been taken if that location's imagery is in a pre-existing database. It does not, however, disclose or suggest realtime projection or video projection.

U.S. Pat. No. 9,091,547 teaches simulation of the view of the ground an airborne observer will have at a specific location and orientation. It does not, however, disclose or suggest realtime projection or video projection nor does it teach realtime sensor data fusion.

U.S. Pat. No. 9,188,444 teaches a system for improving the location accuracy of an object that appears on a georeferenced image. It does not, however, disclose or suggest projecting realtime 3-Dimensional geo-referenced video feeds on a map.

U.S. Pat. No. 9,218,682 uses a database of georeferenced objects and embeds geo-location information from matching images. It does not, however, disclose or suggest projecting 3-Dimensional realtime geo-referenced video feeds on a map.

### SUMMARY OF THE INVENTION

The invention comprises a system for placing remotely acquired video in context by creating a hybrid video, combining the realtime remotely acquired video with real time sensor data representing the geography of the location and 3-Dimentional attitude at which the video was acquired, and allowing a user to control the viewpoint from which the hybrid image is displayed, thereby generating 3-Dimensional, georeferenced, geo-oriented realtime imagery, including video imagery.

The system comprises means for acquiring a remote image, for example a video camera, which captures a real time data feed (which may be single frames or continuous and which may be visible or in a portion of the electromagnetic spectrum not visible to the human eye); a global positioning system (“GPS”) receiver, which reports location metadata associated with the video camera at each instant during image capture; means for determining the orientation of the video camera, for example a 3-Axis compass, which captures the orientation metadata (for example, heading, roll and pitch angles) associated with the video camera at each instant while the video feed is being captured; a computer system on which is stored a database of geographic location metadata and associated imagery for a region of interest and software for fusing images from the realtime video feed with the geographic location metadata and associated imagery and generating a signal which may be translated into a hybrid image for visual display, and a network which connects the system components. The system generates geo-referenced, geo-oriented live footage.

### BRIEF DESCRIPTION OF THE DRAWINGS

FIG. 1 shows a prototype of the remote portion of the system.

FIG. 1(a) is a schematic of the prototype of FIG. 1 identifying the main components.

FIG. 2 is a flow chart of the system.

FIG. 3 is a flowchart of an element of software for processing remote imagery.

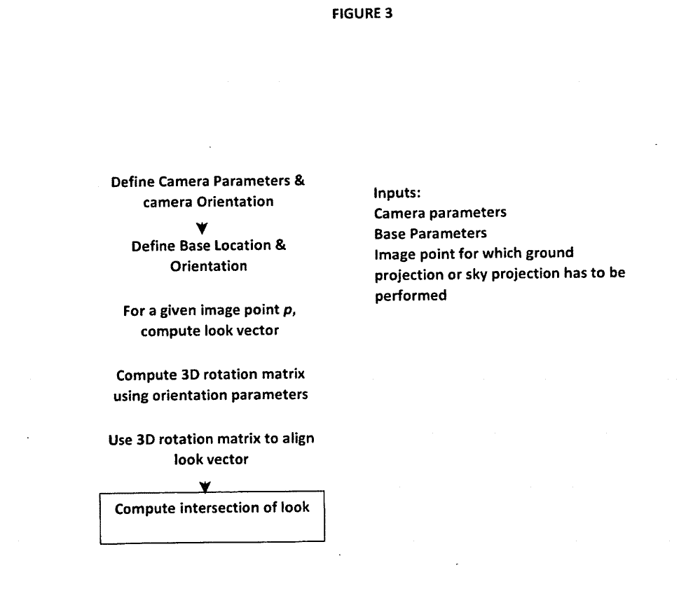

FIG. 4 is an example of two images created by the system, a flat projection and a cylindrical projection.

FIG. 4(a) is a line drawing showing select features of the flat projection of the image of FIG. 4.

FIG. 4(b) is a line drawing showing select features of the cylindrical projection of FIG. 4.

FIG. 4(c) is a line drawing showing select features of an alternative (spherical) projection of the image of FIG. 4 projected as a spherical projection.

FIG. 5 is a schematic of an example of a system suitable for carrying acquiring the two data streams required by the invention.

FIG. 6 is a high-level schematic showing the principal components of the system and their interaction.

FIG. 7 is a flow chart of software suitable for implementing the invention.

FIG. 8 is a representation of experimental data fusing prestored geographical information with a live video feed and environmental data.

### DETAILED DESCRIPTION

There are two principal kinds of “images” involved in the creation of the hybrid image of the invention. A “topographical image” comprises data describing historical or fixed information concerning the general location under consideration and may include data in the form of imagery (which may include images in spectral ranges beyond human vision), geolocation tags (for example, latitude, longitude and elevation) and would typically be acquired ahead of time and stored on a storage medium and organized as a database accessible by a computer.

A “realtime image” comprises data acquired in real time (or at a specific time) and may, in addition to visual images, include images in spectral ranges beyond human vision, geolocation tags describing the location of the image being captured and/or the device capturing the image. Examples of geolocation tags would include latitude, longitude and altitude or elevation of either the device capturing the realtime image or of components of the image, and attitude of the device with respect to a specific plane (for example, a real or artificial horizon) and orientation with respect to a reference (for example, geographic north).

The system of the invention generates georeferenced, geo-oriented live imagery using a video camera, which is used for capturing a real time video feed—a global positioning system (“GPS”) receiver, which is used to establish and update the location metadata associated with the video camera at each instant during the time the video feed is being captured; a 3-Axis compass, which is used to capture the orientation metadata (for example, heading, roll and pitch angles) associated with the video camera at each instant while the video feed is being captured; a computer system on which is stored a database of geographic location metadata and associated imagery for a region of interest and software for fusing images from the realtime video feed with the geographic location metadata and associated imagery and generating a signal which may be translated into a hybrid image for visual display, and a network which connects the video camera, the GPS, the 3-axis compass and the computer system. The network may be wired (for example, a router connected with the video camera, the 3-axis compass and the computer system) or may be wireless (for example, a cellular modem connected with the video camera, the 3-axis compass and the computer system). The system generates geo-referenced, geo-oriented live footage.

Several of the components may in one embodiment be integrated into a single device, for example, into a smartphone that carries a camera, a cellular modem, a GPS and a compass. In an alternative embodiment, the components are connected by a network, for example the internet.

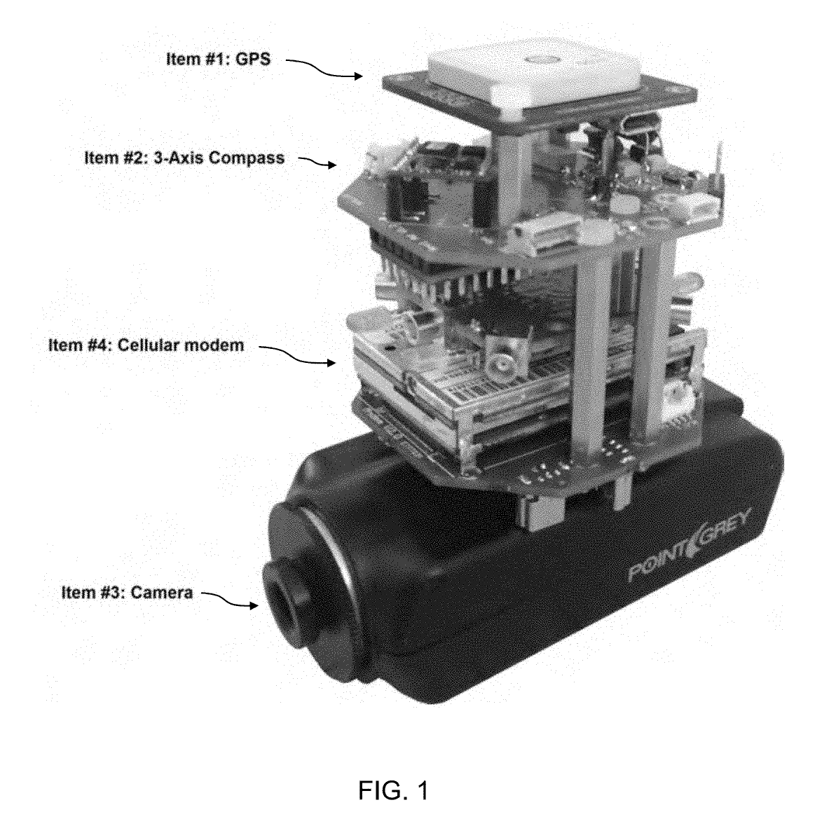

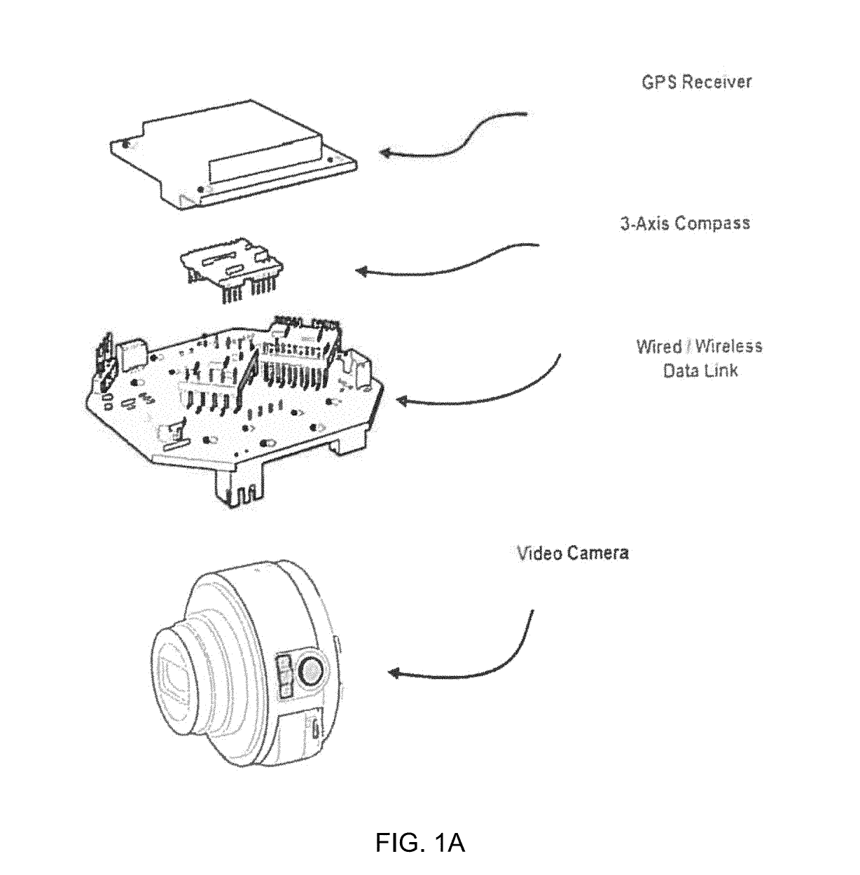

An example of a prototype constructed embodying the invention follows. Referring to FIG. 1, the remote portion of the system comprises a GPS receiver (item #1) and a digital 3-Axis compass (item #2) which are aligned with a camera (item #3) focal point to generate and transmit the location and orientation respectively of a video stream being acquired by the camera. The data from all above components (compass, GPS and camera) are fused to a cellular modem (item #4) for real-time transmission over the internet (or closed/private networks) to a computer at a remote location. (In an alternative embodiment, certain smartphones incorporate a GPS receiver, a digital 3-Axis compass, a camera and a cellular modem already properly aligned and could replace the equivalent components in the prototype.)

The remote computer receives the aforementioned data, and is programmed to generate the 3-Dimensional imagery and display it as a separate layer on top of prestored digital maps to the true location and orientation at which the imagery was acquired under software control. Writing the software for calculation, display and coordination of the 3-dimensional imagery and prestored digital maps is a time-consuming task, but requires no more than receiving the data and using it as the input to trigonometry calculations which are within the skill of those of ordinary skill in the art. Additionally, the software is responsive to user control specifying which images are of interest (location and viewpoint). Again, creation of such software is within the skill of those of ordinary skill in the art. The software should allow a user to obtain a topographical image of an area of interest and provide indexed access to the image to a computer. The indexing should be designed so as to enable the computer to access a particular subset of the topographical image in response to an input from the user, using a database management system.

The topographical image may, for example, be Google® Earth and the computer access may be through the internet using a browser, for example, Firefox.

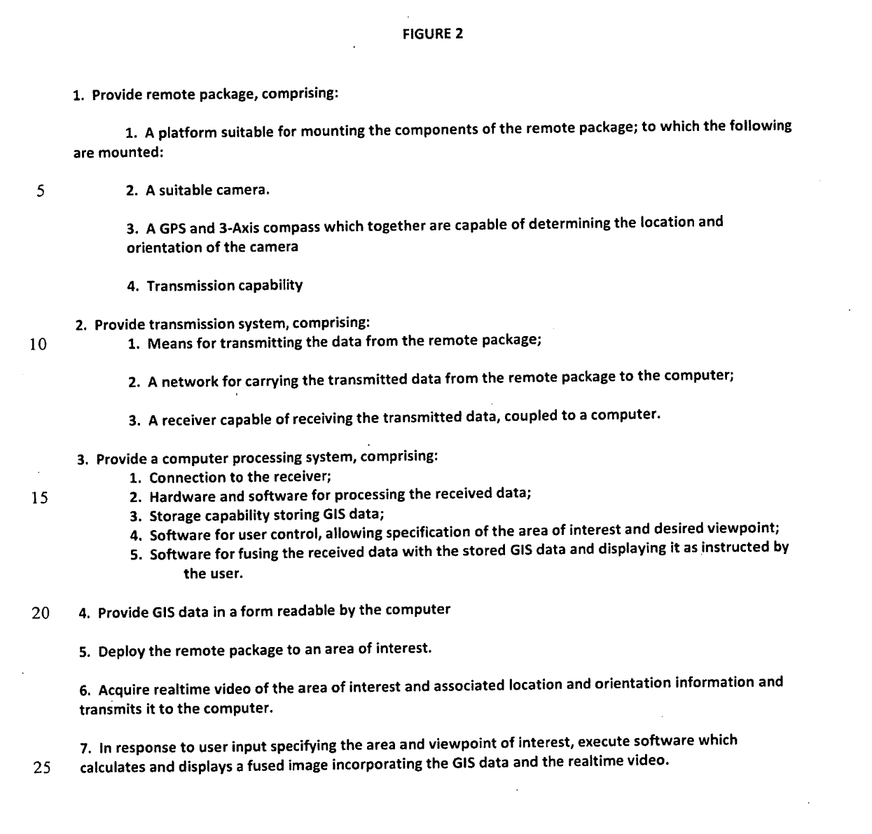

In operation, the user determines a specific realtime image of interest and deploys a remote-controlled video camera system, illustrated in FIG. 1, to the location of the realtime image, for example by using a drone carrying a video camera, a remote control device, a GPS device, a clock (which may be a component of the GPS device) a 3-Axis compass and a cellular modem with access to a network. Once on station, the user activates and orients the video camera toward a location of interest using the remote control device. Once the camera is properly oriented, the user uses the remote control device to activate a data feed (comprising a frame-by-frame time-stamped topographical image acquired by the video camera, and the location of the video camera acquired by the GPS device and the orientation of the video camera acquired by the 3-Axis compass) from the cellular modem, over the network, to the computer, where it is stored. Software running on the computer retrieves the topographical image related to the area from which the realtime image is being captured and the realtime image and, in response to user input designating the viewpoint which the user desires, combines the topographical image and the realtime image by placing the realtime image in the appropriate location and orientation of the topographical image. The placement may be determined using standard trigonometry and geometry using as inputs the location and orientation information transmitted to the computer. The system thereby generates a georeferenced, geo-oriented realtime hybrid image comprising the fused topographical images and realtime images, which may then be displayed on a monitor, printed or otherwise conveyed to the user. An example of such a fused image is shown in FIG. 2. Optionally, additional metadata (for example, the time the image was captured, the location of the camera or of the object being captured, the altitude of the camera, the elevation of various components of the topography or the attitude of the camera) may be displayed or stored as well.

Referring to FIG. 2, the system consists of:

1. A remote package, comprising:
1. A platform suitable for mounting the components of the remote package; to which the following are mounted:
2. A camera. The camera can be of any suitable type, for example a simple Pan-Tilt-Zoom (PTZ) camera or a Fish-Eye camera or a Spherical camera. The projection type is governed by the type of camera used. A PTZ camera uses a planar image plane. A Fish-eye camera uses a cylindrical image plane, while a spherical camera uses a spherical image plane. Cameras are characterized in terms of focal length, horizontal and vertical field of view (FoV) and image size. An internal parameter of detector size may be used in computations, but its value is derived from FoV and image size. A ground or projection surface which is imaged by camera. A ground surface is defined in terms of its distance from camera and is always a plane surface that is being imaged.
3. A GPS and 3-Axis compass which together are capable of determining the location and orientation of the camera (for example, Pan, Tilt and Yaw)
4. Transmission capability, for example a cellular modem, capable of transmitting the data collected by the camera, EPS and to a remote computer for processing and display.

2. A transmission system, comprising:
1. Means for transmitting the data from the remote package;
2. A network for carrying the transmitted data from the remote package to the computer;
3. A receiver capable of receiving the transmitted data, coupled to a computer.

3. A computer processing system, comprising:
1. Connection to the receiver;
2. Hardware and software for processing the received data;
3. Storage capability storing GIS data;
4. Software for user control, allowing specification of the area of interest and desired viewpoint;
5. Software for fusing the received data with the stored GIS data and displaying it as instructed by the user.

The user provides the GIS data in a form readable by the computer and deploys the remote package to an area of interest. The remote package acquires realtime video of the area of interest and associated location and orientation information and transmits it to the computer. In response to user input specifying the area and viewpoint of interest, the computer executes software which calculates and displays a fused image incorporating the GIS data and the realtime video.

A suitable projection may be based on ray tracing. It computes both ground coordinates and above ground bearing vectors that corresponds to any image point. First a 3D look vector is computed that joins the image point and the camera optical centre. This is known as camera internal orientation that is computed. A projection is calculated as a function of camera parameters. Next, a 3D rotation matrix is computed that take into account rotation of mount (Base roll, pitch and yaw), as well as camera orientation (Pan and tilt).

This 3D rotation matrix is combined with look vector to orient the look vector in real earth. A lookVector1 ray that emerges from image location and hit the earth after passing through optical center. This vector is oriented in real earth as per orientation of UAV and camera. The look vector is projected to its target object or earth. Knowing the distance of UAV or camera from earth it is possible to calculate the exact distance along this line to hit the ground.

Conceptually, in overview the process of creating what is in effect an embodiment of video information and associated environmental information in a display operates as follows. A device, for example a smartphone or a camera with suitable environmental sensors, is used to simultaneously acquire a stream of video information and an associated stream of environmental information (for example, location, altitude, attitude, and other desired information). The two streams are multiplexed so as to create a multiplexed stream of information, which is transmitted (for example, using wifi or the cellular modem of a smart phone) to a remote location where a user has a computer with a receiver capable of receiving said multiplexed stream, a processor capable of demultiplexing said multiplexed stream back into the original stream of video information and stream of environmental information and converting them into a visually display. Upon receipt, the multiplexed stream is separated into a stream of video information and a stream of environmental information. The computer is provided with memory and software capable of providing access to a pre-stored database of topographical information and database management software. The computer is instructed to access the topographical information associated with the location from which the stream of video information was captured as identified by the stream of environmental information. This allows the computer to determine the location from which the stream of video information was captured and the point of view of the device which captured it (location in space, attitude and any other desired information) and to construct a virtual map fusing the topographical information with the stream of video information so as to allow a user to view the stream of video information in the context of, and from the desired point of view of, a virtual observer located at a selected point and viewpoint on the virtual map. The resulting virtual image may then be displayed in any fashion which is suitable, for example, on a monitor.

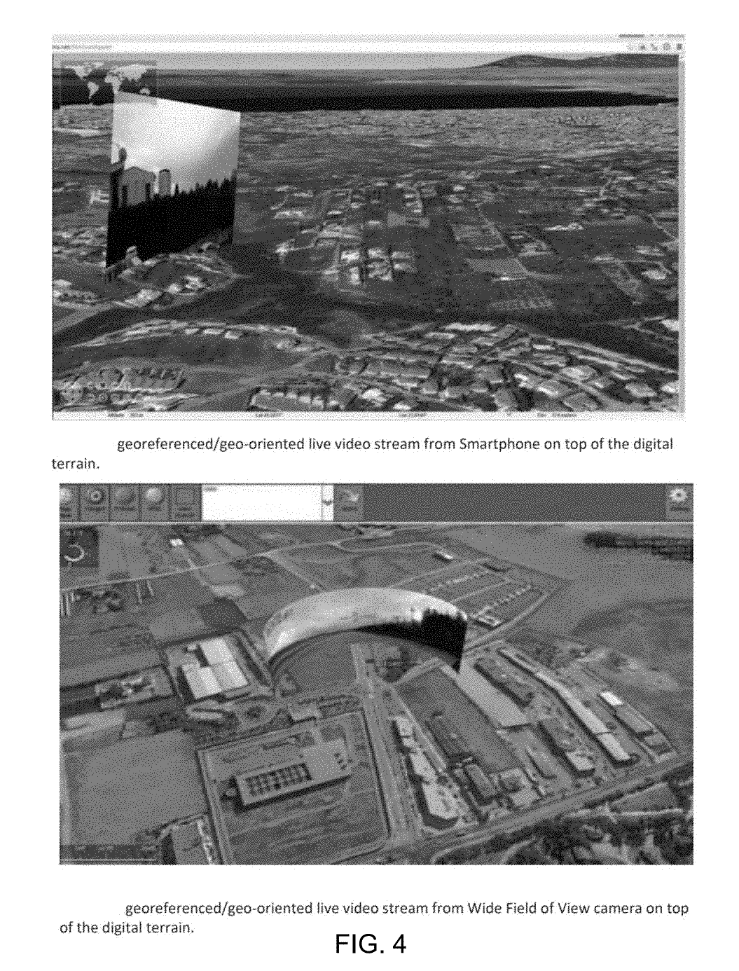

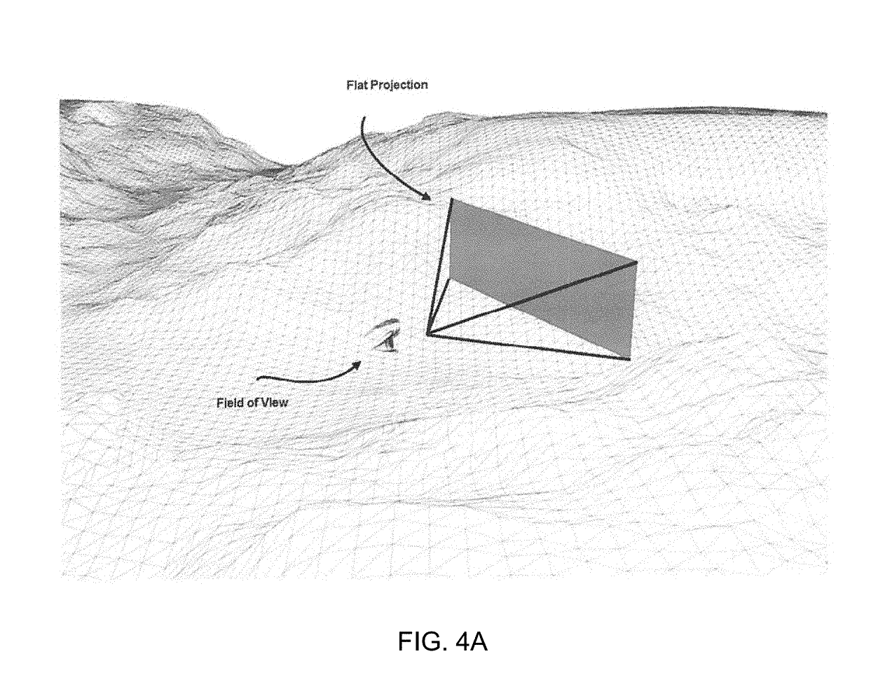

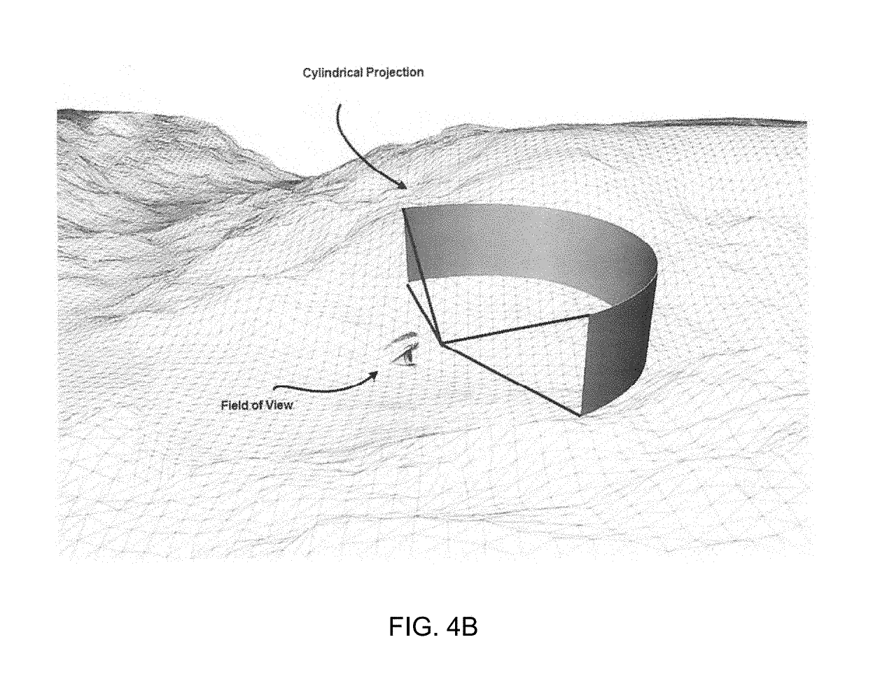

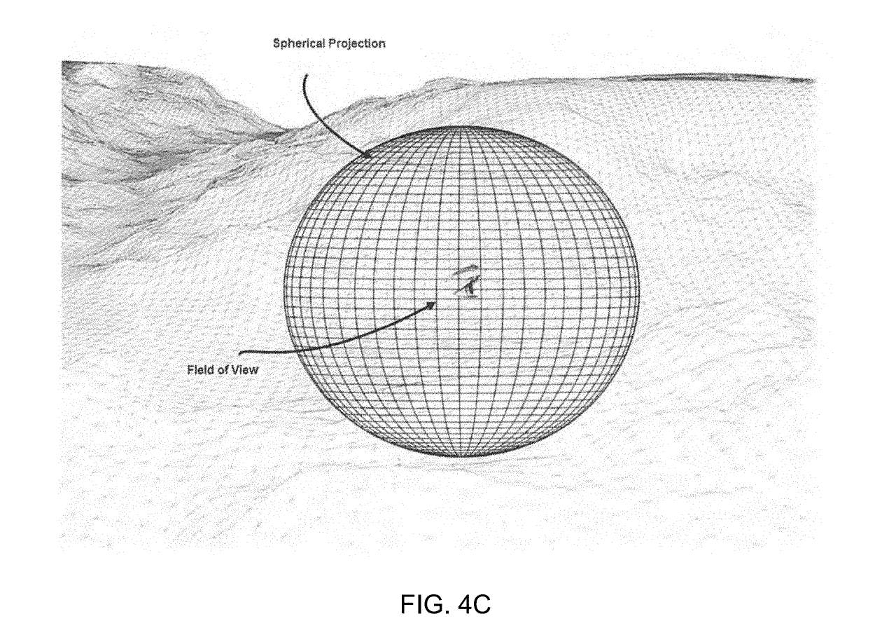

FIG. 4 illustrates a conceptual visualization of the fused image data. The realtime video streams may be visualized in a number of ways, including as a flat projection as shown in FIG. 4(a), as a cylindrical projection as shown in FIG. 4(b) or as a spherical projection as shown in FIG. 4(c); other projections could be used for specialized purposes, using geometry and programming that would be within the level of skill of those of ordinary skill in the art.

### Example

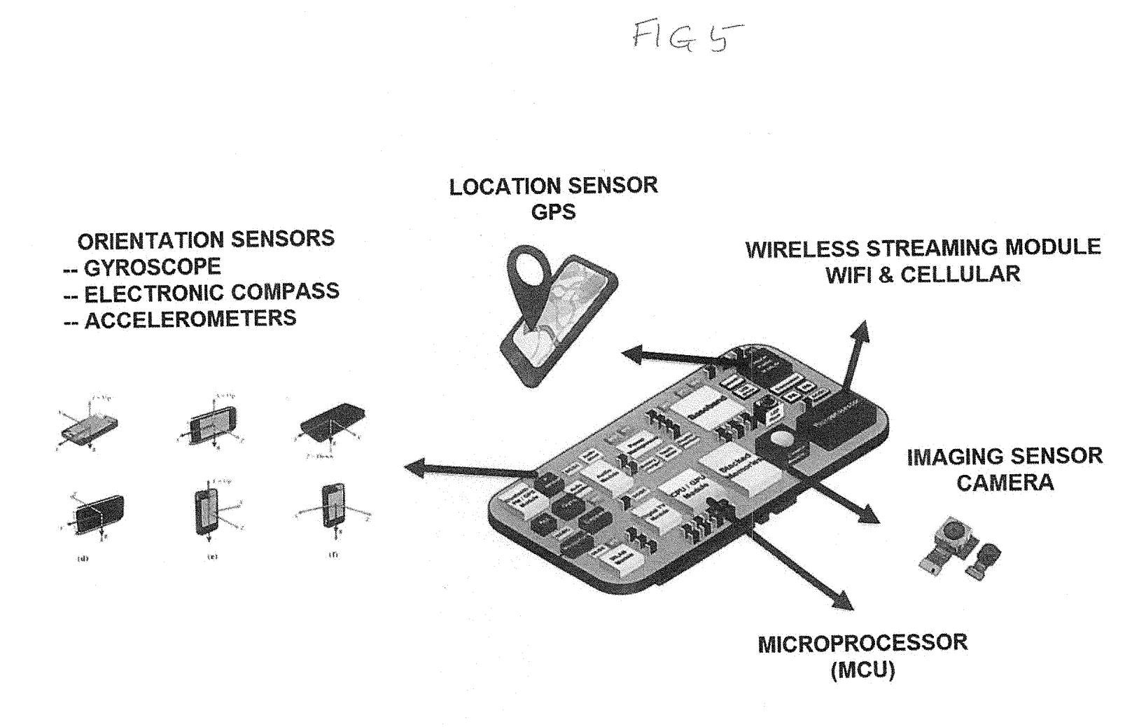

The system may utilize the live video streaming capability of a smartphone coupled with a “geo-registration” component so as to create a streamed video that has location and orientation data embedded to it as video metadata. The location and orientation data may be extracted from the an embedded GPS (for location), compass, accelerometers and gyros (for orientation) if the smartphone is so equipped, or may be acquired from external equipment. FIG. 5 illustrates a suitable smartphone, incorporating an image sensor (camera), a location sensor (gps), multiple orientation sensors (gyroscope, compass, accelerometers) and a microprocessor. The combined streamed video therefore differs from, for example, video chat and video conferencing applications, in that it is enriched with location and orientation data. This enriched footage is streamed then over WiFi and/or cellular networks to a client, which may be another smartphone, a tablet, a server, a laptop, a desktop or other device.

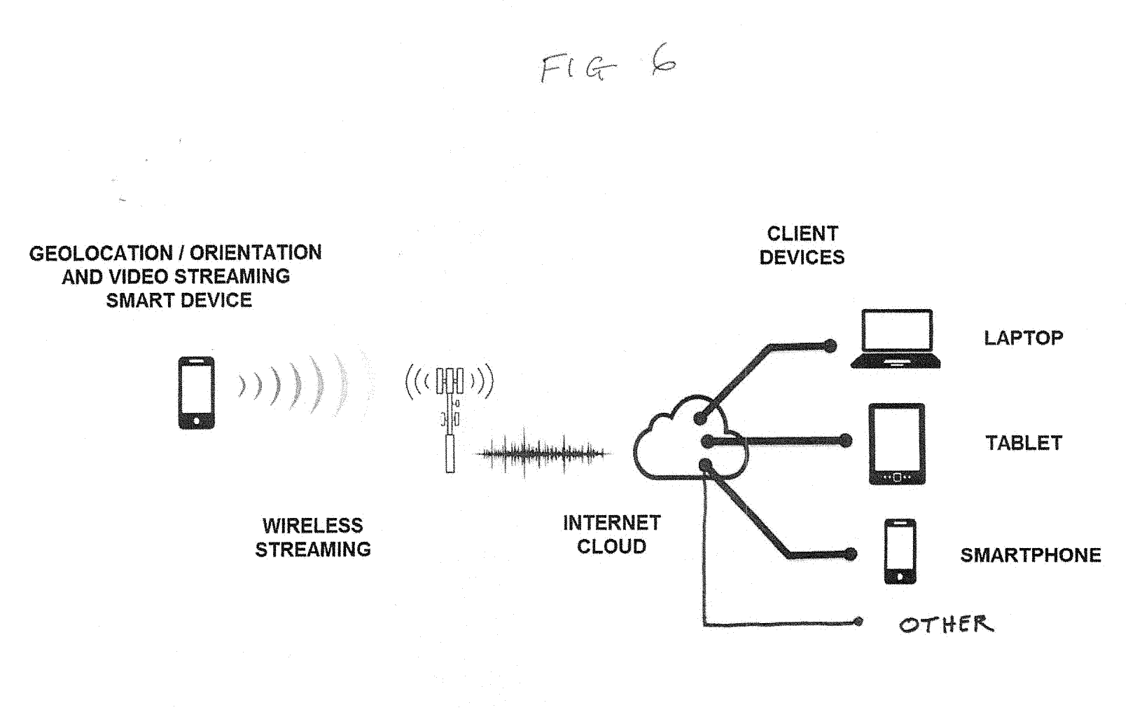

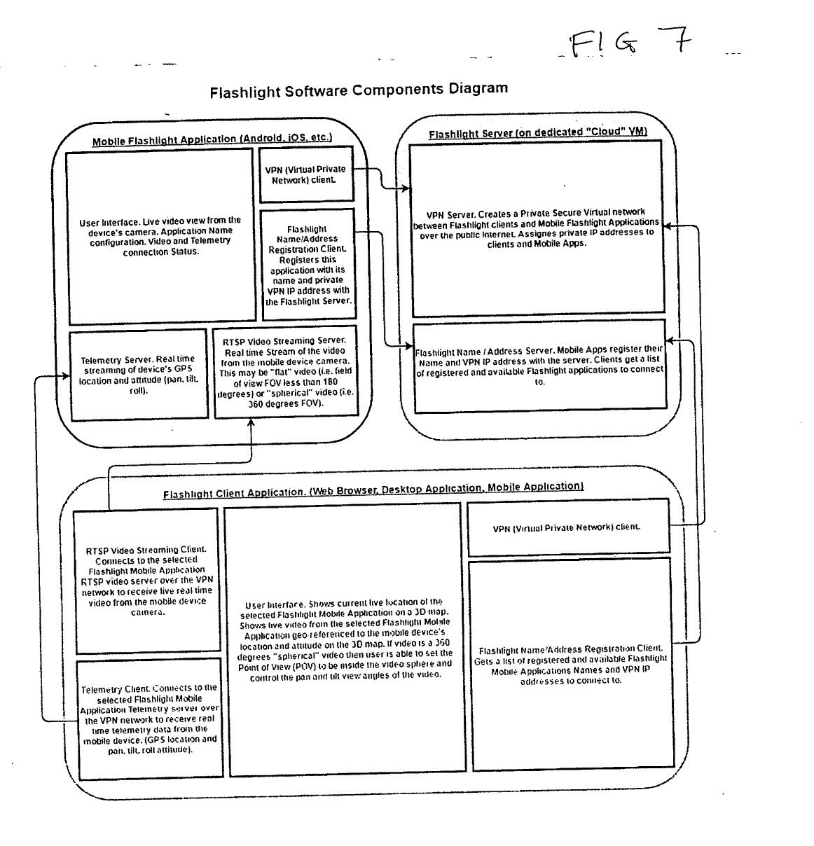

FIG. 6 illustrates the process in overview. Note that location and orientation data are combined with live video from a camera using a smartphone's microprocessor to create a single data package which may be streamed wirelessly over the Internet or using wifi or the smartphone's cellular connection. FIG. 7 provides a flow chart of software suitable for controlling the various components and carrying out the invention. Note that a remote server resolves addressing between the serving devices which stream the multiplexed streams and one or more client devices which receive the multiplexed stream and process it for display.

On the receiving side, a pairing application separates the received location/orientation data from the video and uses them to render an invisible frame onto a digital map that follows the same orientation in all 3-axis as the smartphone attitude used to generate this attitude. Also, the GPS information are used so this invisible frame is placed on the exact location where the smartphone resides.

At the same time, the application textures the invisible frame with the received video frames so that the video is geo-registered and geo-oriented by presenting it on a digital map at the location of and oriented from the perspective of the smartphone which was used to generate the video.

This is accomplished by conceptually four elements: data (including video data) acquisition, telemetry, processing and display.

Data acquisition is carried out by using the smartphone's camera to acquire the desired video and the smartphone's positioning features (to the extent present or as supplemented by additional hardware) to acquire environmental data (for example, gps positioning, altitude, attitude—pan, tilt, roll-, acceleration or other data of interest to the user).

Telemetry begins with multiplexing the acquired data with the video stream. This means that the RTSP H.264 video streams contains a second metadata track that includes the environmental data. The multiplexed data is then transmitted—for example, using wifi or cellular—as a transmission stream to a client location.

At the client location the transmission stream is de-multiplexed so as to separate it into a video stream and an environmental stream.

The environmental data is parsed and processed so as to display the location of the smartphone on a map at a location and with its orientation corresponding to the environmental data, and also to display the 3D projection of the live video stream both flat video (FOV less than 180) or spherical video (FOV greater than 180) at the correct “projected” location and FOV from the location of the phone's camera on the 3D map. All this information is streamed and updated real time so that the user of the client applications can “follow” the smartphone it is connected to and see the changes in location, attitude and video on the map.

Display may be controlled by the user extracting each video frame as it arrives real time and selecting a display mode. If the video is flat (less than 180 degrees field of view) then the video is shown on the map as a flat rectangular frame. The location and “attitude” of this frame on the 3D map is calculated using the environmental data from the phone. Knowing the phone location and the camera FOV angles the flat rectangular frame can be drawn at the appropriate location on the map. This location/attitude changes real time with the location/attitude of the phone. The user may also change its point of view around the map and locate itself at the phone location to have the POV of the video from the location of the phone itself.

If the video is spherical (field of view greater than 180 (Fisheye frame). Normally the field of view is 360 horizontally by some value greater than 180 and less than 360 vertically, for example 360H×240V) the processing is more complicated. In this case, the basic process is to create a virtual 3D “hemisphere” centered at the location of the phone and taking into consideration the phones attitude and camera FOV angles. This hemisphere is a “wire frame” and its surface consists of many vertices/triangles. The higher the number of vertices and triangles the smoother the appearance of the sphere on the display (the “wire frame” is not shown on the display). The hemisphere location/attitude is, once again, updated real time from the phone data.

Once the hemisphere wire frame is calculated then the fisheye video frames that are being received real time from the phone's camera are “textured/draped” over the hemisphere wire frame so that the user sees the live video as a 3D sphere on the map. The fisheye video frames from the camera cannot be applied directly as a texture to the hemisphere but need to be “de-warped/stretched” over the hemisphere wire frame. All this occurs real time on the client device (which may be a PC, another cell phone, a tablet, a server, a desktop computer or other device).

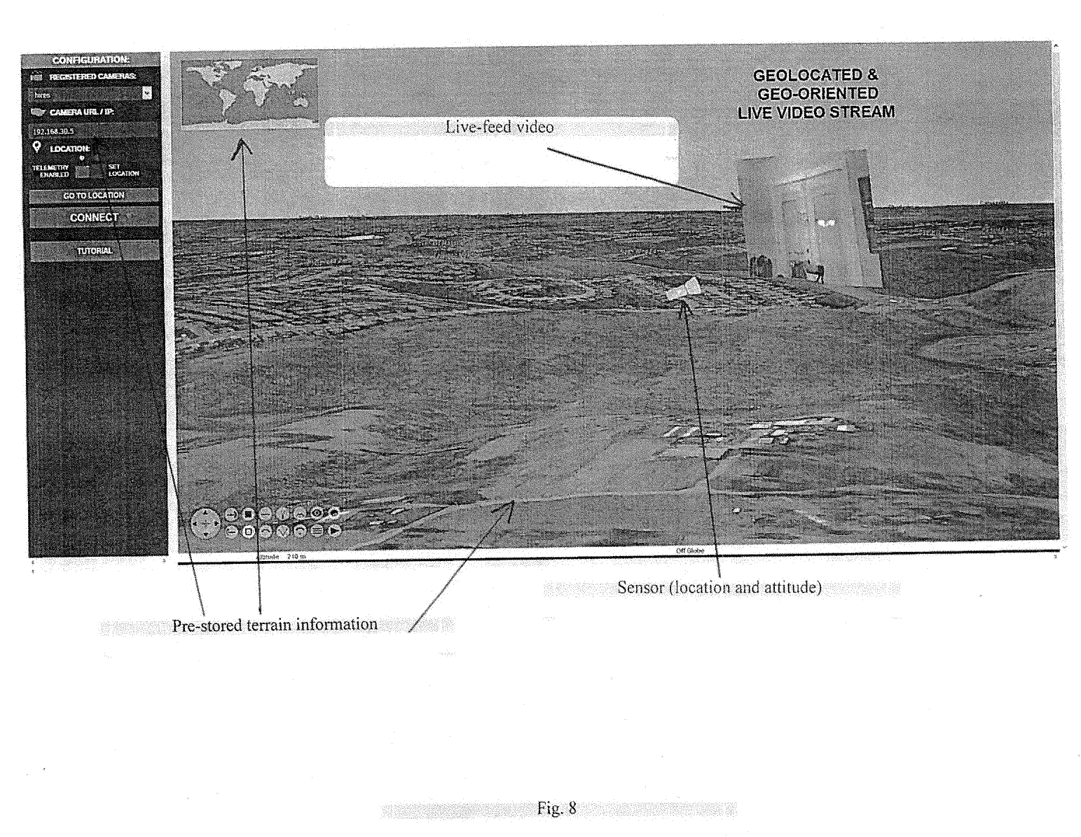

As with the flat view the client user may change the point of view from “outside” the sphere (i.e. viewing the map, phone location and video sphere from above) to inside the sphere as the point of view of the camera, allowing the user to “look around” the sphere without the distortion of the original fisheye video frame. FIG. 8 illustrates a suitable display system displaying a live video feed fused to prestored terrain information and location and attitude information of the sensor generating the live video feed.

1. A process for generating a 3-Dimensional, georeferenced, geo-oriented realtime hybrid video comprising,
providing a platform coupled to a video camera controlled by a remote control device, a GPS device coupled to said video camera so as to determine the location of the video camera, a clock colocated with said video camera so as to enable determination of the time at which an image captured by said video camera was captured, a 3-Axis compass mounted to said platform in such a manner as to enable determination of the attitude of said video camera at any given time and a processor electronically connected to each of said video camera, said clock and said 3-axis compass in such a manner as to allow it to receive data from said video camera, said clock and said 3-axis compass and transmit said data to a computer via a communications network;
activating said video camera by said remote control device when said video camera is able to capture a realtime image of interest, simultaneously activating capture of location information by said GPS device, capture of the time by said clock and capture of attitude information by said 3-axis computer; collecting the information so captured by the processor and conversion of said data to a form compatible with transmission via the network;
transmitting the information so captured to the computer via a network;
receiving the information so captured by said computer;
providing said computer with access to a database of topographical information and database management software;
instructing said computer to access the topographical information associated with the location from which the realtime image was captured;
instructing said computer to fuse said topographical information with said realtime information so as to generate a 3-Dimensional, georeferenced, geo-oriented realtime hybrid image comprising the fused topographical image and realtime image;
displaying said fused topographical image and realtime image on a monitor.

2. A process for creating an embodiment of video information and associated environmental information comprising:
simultaneously acquiring a stream of video information and an associated stream of environmental information;
multiplexing said stream of video information with said stream of environmental information so as to create a multiplexed stream of information;
transmitting said multiplexed stream of information to a remote location;
receiving said multiplexed stream as an input to a computer having a receiver capable of receiving said multiplexed stream, a processor capable of demultiplexing said multiplexed stream into a stream of video information and a stream of environmental information and converting them into a visually display;
demuliplexing said multiplexed stream into a stream of video information and a stream of environmental information;
providing said computer with access to a database of topographical information and database management software;
instructing said computer to access the topographical information associated with the location from which the stream of video information was captured;
instructing said computer to fuse said topographical information with said stream of video information so that the stream of video information is displayed on a virtual map at a location corresponding on said map with the physical location from which the stream of video information was captured; and displaying said stream of video information so located on said map on a monitor.

3. A computer system for displaying geo-referenced, geo-orientated video images on a map image, comprising:
a user computing device including a display device and a processor coupled to the display device, the processor programmed to:
receive a data feed from a mobile computing device, the mobile computing device including a location sensor, an orientation sensor and a camera including an imaging sensor, the data feed including video image data acquired by the imaging sensor, location data acquired by the location sensor, and orientation data acquired by the orientation sensor;
determine a location of the mobile computing device based on the received location data;
generate and display a 3-dimensional (3D) map image on the display device including the determined location of the mobile computing device;
generate and display a camera location icon on the 3D map image at the determined location of the mobile computing device;
determine an orientation of the mobile computing device based on the orientation data and generate and display a video frame object overlaying a portion of the 3D map image, the video frame object being displayed having an orientation matching the determined orientation of the camera of the mobile computing device; and
display the video images acquired by the imaging sensor onto the video frame object.

4. The computer system of claim 3, wherein the data feed includes the image data, the location data, and the orientation data being acquired by the mobile computing device in real-time.

5. The computer system of claim 4, wherein the processor is programmed to modify the orientation and the location of the video frame object based on the location data and the orientation data being acquired by the mobile computing device in real-time.

6. The computing system of claim 3, wherein the processor is programmed to generate and display the video frame object having a shape based on a field-of-view (FOV) of the camera.

7. The computer system of claim 3, wherein the processor is programmed to:
establish a secured communication network between the mobile computing device and the user computing device; and
receive the data feed from the mobile computing device via the secured communication network.

8. The computer system of claim 7, wherein the processor is programmed to:
display a list of mobile computing devices on the display device of the user computing device;
receive a selection of one of the mobile computing devices included in the list and transmit a request to receive a data feed from the selected mobile computing device;
receive the data feed from the selected mobile computing device including video image data, location data, and orientation data being acquired by the selected mobile computing device in real-time; and
display a video images acquired by the selected mobile computing device on the 3D map image.

9. The computer system of claim 3, wherein the processor is programmed to:
determine a 3D coordinate location of a target object being displayed within the video image based on topographical data included in the 3D map image; and
display the determined 3D coordinate location on the display screen.

10. The computer system of claim 9, wherein the processor is programmed to:
determine the 3D coordinate location of the target object including:
determine a 3D location of an optical center of the camera based on the location data and orientation data received from the mobile computing device;
select an image point within the video image associated with the target object;
determine a look vector extending from an optical center of the camera and through the selected image point;
determine an intersection point at which the look vector intersects a location on the 3D map and identify a 3D coordinate location of the intersection point; and
associate the identified 3D coordinate location of the intersection point with the target object.

11. The computer system of claim 3, wherein the processor is programmed to:
receive topographical information from a 3^{rd} party server computer; and
determine the location of the mobile computing device based on the received location data and the received topographical information.

12. A method of operating a user computing device for generating a geo-referenced, geo-orientated video images on a map image, the user computing device including a display device and a processor coupled to the display device, the method comprising the processor performing the steps of:
receiving a data feed from a mobile computing device, the mobile computing device including a location sensor, an orientation sensor and a camera including an imaging sensor, the data feed including video image data acquired by the imaging sensor, location data acquired by the location sensor, and orientation data acquired by the orientation sensor;
determining a location of the mobile computing device based on the received location data;
generating and displaying a 3-dimensional (3D) map image on the display device including the determined location of the mobile computing device;
generating and displaying a camera location icon on the 3D map image at the determined location of the mobile computing device;
determining an orientation of the mobile computing device based on the orientation data and generate and display a video frame object overlaying a portion of the 3D map image, the video frame object being displayed having an orientation matching the determined orientation of the camera of the mobile computing device; and
displaying the video images acquired by the imaging sensor onto the video frame object.

13. The method of claim 12, wherein the data feed includes the image data, the location data, and the orientation data being acquired by the mobile computing device in real-time.

14. The method of claim 13, further comprising the processor performing the steps of modifying the orientation and the location of the video frame object based on the location data and the orientation data being acquired by the mobile computing device in real-time.

15. The method of claim 12, further comprising the processor performing the steps of generating and displaying the video frame object having a shape based on a field-of-view (FOV) of the camera.

16. The method of claim 12, further comprising the processor performing the steps of:
establishing a secured communication network between the mobile computing device and the user computing device; and
receiving the data feed from the mobile computing device via the secured communication network.

17. The method of claim 16, further comprising the processor performing the steps of:
displaying a list of mobile computing devices on the display device of the user computing device;
receiving a selection of one of the mobile computing devices included in the list and transmitting a request to receive a data feed from the selected mobile computing device;
receiving the data feed from the selected mobile computing device including video image data, location data, and orientation data being acquired by the selected mobile computing device in real-time; and
displaying a video images acquired by the selected mobile computing device on the 3D map image.

18. The method of claim 12, further comprising the processor performing the steps of:
determining a 3D coordinate location of a target object being displayed within the video image based on topographical data included in the 3D map image; and
displaying the determined 3D coordinate location on the display screen.

19. The method of claim 18, further comprising the processor performing the steps of:
determining the 3D coordinate location of the target object including:
determining a 3D location of an optical center of the camera based on the location data and orientation data received from the mobile computing device;
selecting an image point within the video image associated with the target object;
determining a look vector extending from an optical center of the camera and through the selected image point;
determining an intersection point at which the look vector intersects a location on the 3D map and identify a 3D coordinate location of the intersection point; and
associating the identified 3D coordinate location of the intersection point with the target object.

20. The method of claim 12, further comprising the processor performing the steps of:
receiving topographical information from a 3^{rd} party server computer; and
determining the location of the mobile computing device based on the received location data and the received topographical information.
